(19) United States
(12) Patent Application Publication
(10) Pub. No.: US 2009/0095368 A1
(43) Pub. Date: Apr. 16, 2009

(54) HIGH FRICTION INTERFACE FOR IMPROVED FLOW AND METHOD

(75) Inventors: Michael H. Johnson, Katy, TX (US); Edward J. O'Malley, Houston, TX (US); Bennett M. Richard, Kingwood, TX (US)

Correspondence Address: CANTOR COLBURN, LLP, 20 Church Street, 22nd Floor, Hartford, CT, 06103, US

(73) Assignee: BAKER HUGHES INCORPORATED, HOUSTON, TX (US)

(21) Appl. No.: 12/245,958

(22) Filed: Oct. 6, 2008

Related U.S. Application Data
(60) Provisional application No. 60/978,967, filed on Oct. 10, 2007.

(51) Int. Cl. F15D 1/04

(52) U.S. Cl. 138/39; 138/177

(57) ABSTRACT

A tubular body for flowing fluid includes an inside diameter surface of the tubular body; and a surface treatment of the inside diameter surface sufficient to cause a viscous interaction with a fluid flowing therethrough and method.

### CROSS REFERENCE TO RELATED APPLICATION

The present application claims priority to U.S. Provisional Patent Application Ser. No. 60/978,967, filed Oct. 10, 2007, the entire contents of which are specifically incorporated herein by reference.

### BACKGROUND

Efficiency is the key to the success of nearly every large scale business. Efficiency translates relatively directly into greater profit in virtually all businesses as well. In the hydrocarbon recovery industry the same precepts hold true. Over many years of hydrocarbon production, research and development dollars have been spent on a plethora of devices and methods aimed at improving access to hydrocarbon reserves, enhancing recoverability of those reserves, controlling multiple zones to eliminate or alleviate contaminants entering a well and even treating the recovered hydrocarbon itself to reduce density thereof to encourage movement to the surface. Even considering the many other improvements in the overall recovery process, the art has not heretofore proposed any method and apparatus by which movement of fluid itself could be speeded.

Methods and apparatus capable of improving flow speed would be well received by the art, as production rates would be improved while energy expended to recover target fluids would be reduced. This, of course, would improve efficiency of the hydrocarbon recovery process thereby improving profitability.

### SUMMARY

A tubular body for flowing fluid includes an inside diameter surface of the tubular body; and a surface treatment of the inside diameter surface sufficient to cause a viscous interaction with a fluid flowing therethrough.

A method for improving fluid flow in a tubular body includes treating an inside diameter surface of the tubular body to increase a coefficient of friction thereof; flowing a fluid therethrough; viscously interacting a portion of the flowing fluid with the inside diameter surface of the tubular body; and causing a shear plane to form between a viscous interaction layer of the fluid and a faster flowing portion of the fluid.

### BRIEF DESCRIPTION OF THE DRAWINGS

Referring now to the drawings wherein like elements are numbered alike in the several Figures:

FIG. 1 is a perspective view of a tubular body illustrating an inside dimension surface;

FIG. 2 is a schematic view of a viscous interaction flow and a central flow in the tubular;

FIG. 3 is a schematic view of a surface treatment applied to the tubular body of FIG. 1;

FIG. 4 is a schematic view of an alternate surface treatment applied to the tubular body of FIG. 1;

FIG. 5 is a schematic view of another alternate surface treatment applied to the tubular body of FIG. 1; and

FIG. 6 is a schematic view of another alternate surface treatment applied to the tubular body of FIG. 1.

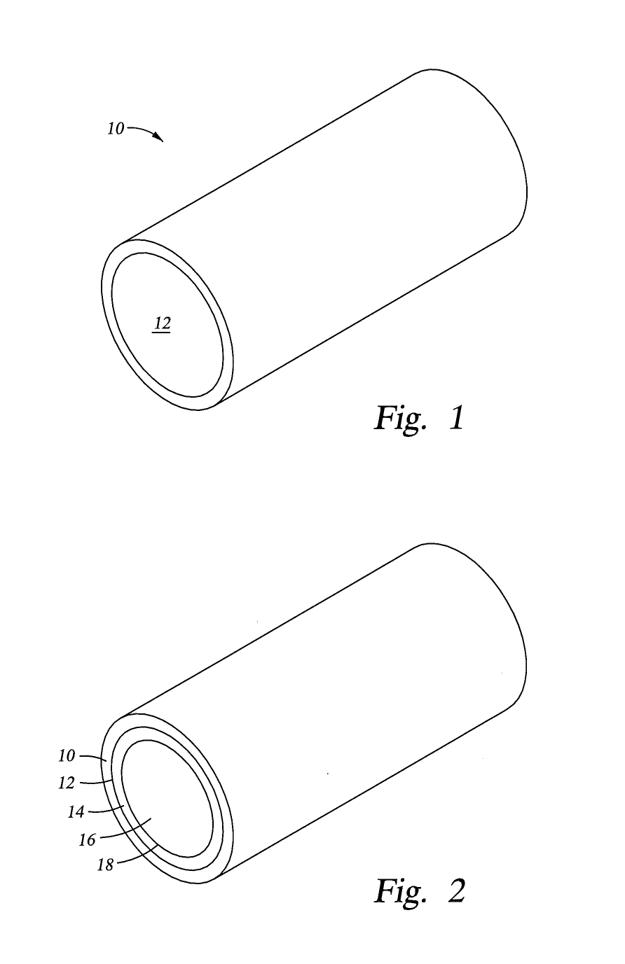

### DETAILED DESCRIPTION

Improvement in fluid flow rate within a tubular body 10 can be accomplished by reducing resistance to the fluid flowing therein. Reduction in resistance to the flowing fluid such as a hydrocarbon fluid is achieved by reducing friction experienced by the bulk of the flowing fluid. Friction can be reduced by either increasing the coefficient of friction at an inside diameter surface 12 of the tubular 10 or conversely by reducing the coefficient of friction at surface 12. While seemingly contradictory, both arrangements achieve the results sought herein. Reducing friction in a tubular that is subject to hydrocarbon flows that inherently include sand, acid, and other contaminants and harsh components is very difficult to do because the environmental conditions in the well bore tend to degrade highly polished low friction surfaces. Therefore it has been determined by the present inventors that increasing the friction of the tubulars used to transport fluid hydrocarbons yields better and more long lasting results.

With respect to improving flow by increasing a coefficient of friction of surface 12, it is necessary to create a viscous interaction layer at the surface 12 that sufficiently slows the fluid of that layer to facilitate a shear in the fluid. What is created then, taking a cylindrical tubular 10 as an example, is an annulus of a viscous interaction layer 14 whose velocity is substantially retarded due to the high friction at the surface 12 and a cylinder of fluid 16 moving much more quickly such that a shear plane 18 is maintained between the two flows. Providing that a sufficient velocity differential is maintained, the flows will not be turbulent but rather will remain substantially laminar in movement thereby maintaining the very low friction shear slip plane between the two fluid flows.

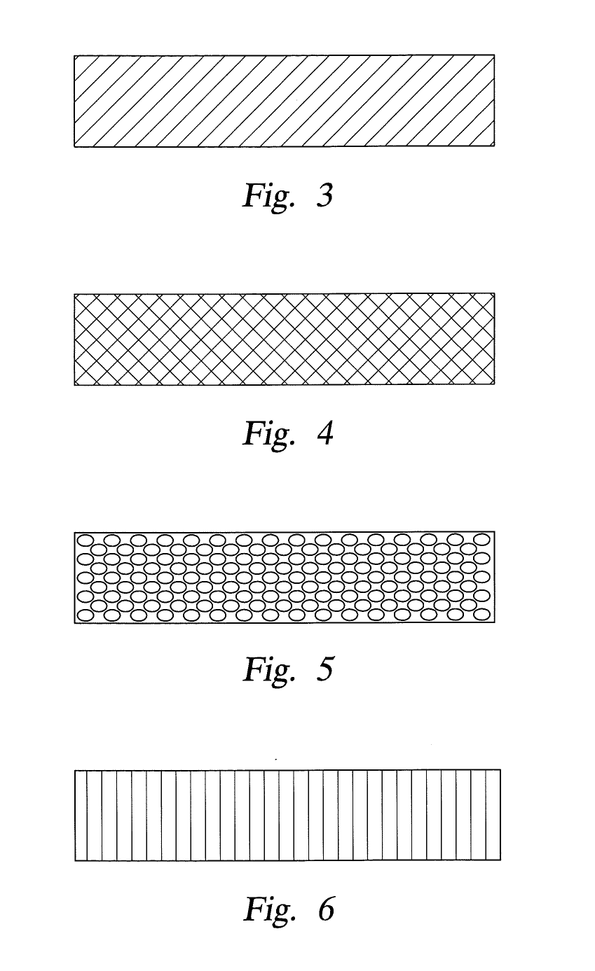

FIGS. 3-6 represent configurations for surface 12 that provide sufficient coefficient of friction for particular fluids to generate the shear plane required to obtain the flow benefits as taught in conjunction with this embodiment such as parallel scoring (FIG. 3), knurling (FIG. 4), dimpling or raised bump surface (FIG. 5), annular scoring (FIG. 6).

While preferred embodiments have been shown and described, modifications and substitutions may be made thereto without departing from the spirit and scope of the invention. Accordingly, it is to be understood that the present invention has been described by way of illustrations and not limitation.

1. A tubular body for flowing fluid comprising:
an inside diameter surface of the tubular body;
a surface treatment of the inside diameter surface sufficient to cause a viscous interaction with a fluid flowing therethrough.

2. The tubular body as claimed in claim 1 wherein the surface treatment increases a coefficient of friction of the inside diameter surface.

3. The tubular body as claimed in claim 1 wherein the viscous interaction develops a layer of fluid moving sufficiently slowly in the tubular body to initiate and maintain a shear plane between the layer and a volume of fluid movable within a portion of the tubular body defined by the layer.

4. The tubular body as claimed in claim 3 wherein the layer is annular.

5. The tubular body as claimed in claim 1 wherein the surface treatment is parallel scoring.

6. The tubular body as claimed in claim 1 wherein the surface treatment is knurling.

7. The tubular body as claimed in claim 1 wherein the surface treatment is dimpling.

8. The tubular body as claimed in claim 1 wherein the surface treatment is raised bumps.

9. The tubular body as claimed in claim 1 wherein the surface treatment is annular scoring.

10. A method for improving fluid flow in a tubular body comprising:
treating an inside diameter surface of the tubular body to increase a coefficient of friction thereof;
flowing a fluid therethrough;
viscously interacting a portion of the flowing fluid with the inside diameter surface of the tubular body;
causing a shear plane to form between a viscous interaction layer of the fluid and a faster flowing portion of the fluid.

11. The method as claimed in claim 10 wherein the treating is parallel scoring.

12. The method as claimed in claim 10 wherein the treating is knurling.

13. The method as claimed in claim 10 wherein the treating is dimpling.

14. The method as claimed in claim 10 wherein the treating is creating raised bumps.

15. The method as claimed in claim 10 wherein the treating is annular scoring.

16. The method as claimed in claim 10 wherein the method further comprises maintaining a fluid flow velocity to maintain the shear plane between the viscous interaction layer and the portion of the fluid flowing therethrough.
